(19) United States
(12) Patent Application Publication
(10) Pub. No.: US 2015/0197974 A1
(43) Pub. Date: Jul. 16, 2015

(54) OPENING AND CLOSING APPARATUS FOR OPENING AND CLOSING MEMBER

(71) Applicant: AISIN SEIKI KABUSHIKI KAISHA, Kariya-shi (JP)

(72) Inventors: Seiichi SUZUKI, Miyoshi-shi (JP); Shin SAKAI, Kariya-shi (JP); Eisuke NAKANISHI, Kariya-shi (JP)

(73) Assignee: AISIN SEIKI KABUSHIKI KAISHA, Kariya-shi (JP)

(21) Appl. No.: 14/595,376

(22) Filed: Jan. 13, 2015

(30) Foreign Application Priority Data
Jan. 14, 2014 (JP) 2014-004066

(51) Int. Cl. E05F 15/643; B60J 5/06; B60J 5/04

(52) U.S. Cl. CPC E05F 15/643; B60J 5/047; B60J 5/06; E05Y 2900/531

(57) ABSTRACT

An opening and closing apparatus for an opening and closing member includes a support member, a transmission belt, a plurality of pulleys including a pair of driven pulleys, a first support wall portion including a first support recess portion, a second support wall portion including a second support recess portion coaxial with the first support recess portion, the second support wall portion being disposed to face the first support wall portion, and a support pin including a first end portion fitted in the first support recess portion, a second end portion fitted in the second support recess portion, and a shaft portion formed at an intermediate portion in an axial direction to be sandwiched between the first support wall portion and the second support wall portion and rotatably supporting each of the driven pulleys, the shaft portion being eccentric relative to the first end portion and the second end portion.

### CROSS REFERENCE TO RELATED APPLICATIONS

This application is based on and claims priority under 35 U.S.C. §119 to Japanese Patent Application 2014-004066, filed on Jan. 14, 2014, the entire content of which is incorporated herein by reference.

### TECHNICAL FIELD

This disclosure generally relates to an opening and closing apparatus for an opening and closing member.

### BACKGROUND DISCUSSION

A known opening and closing apparatus for an opening and closing member is disclosed, for example, in JP4296136B which will be hereinafter referred to as Reference 1. The opening and closing apparatus disclosed in Reference 1 includes a step panel serving as a support member, a drive portion provided at the step panel, a driving pulley driven by the drive portion, a pair of driven pulleys provided at front and rear end portions of the step panel respectively, a belt wound at the driving pulley and the driven pulleys to serve as a transmission belt, and a pair of idler pulleys controlling a tension and an operating route of the belt. The driven pulleys and the idler pulleys are fixed to the step panel via an attachment bracket. A vehicle door serving as the opening and closing member is connected to the belt.

In addition, a known opening and closing apparatus for an opening and closing member is disclosed, for example, in JP2011-105263A which will be hereinafter referred to as Reference 2. The opening and closing apparatus disclosed in Reference 2 includes a step panel made of resin. The step panel is integrally formed with a support portion of a driven pulley, for example.

According to the opening and closing apparatus disclosed in Reference 1, in a case where the tension of the belt is adjusted, the idler pulleys may be displaced along with the attachment bracket in a direction to come closer to or separate from the belt, which results in rearrangements of the idler pulleys and the attachment bracket. In this case, in order to adjust the tension of the belt that is wound annularly, the idler pulleys and the attachment bracket need to be greatly displaced.

In order to effectively adjust the tension of the belt, at least the position of one of the pair of driven pulleys provided at the front and rear end portions of the step panel may be adjusted together with the attachment bracket. Nevertheless, because each of the driven pulleys is disposed at the end portion of the step panel, the movement of each of the driven pulleys towards an outer edge of the step panel for increasing the tension of the belt, for example, may have limitations.

In addition, according to the opening and closing apparatus disclosed in Reference 2, the support portion of the driven pulley is integrally formed at the step panel. Thus, a further downsizing of the apparatus may ease limitations for displacing the driven pulley to an outer edge of the step panel. Nevertheless, in order to adjust the tension of the belt, the position of the support portion of the driven pulley is necessary adjusted by a usage of a die for forming the support portion. As a result, an increase of manufacturing hours may be inevitable.

A need thus exists for an opening and closing apparatus for an opening and closing member which is not susceptible to the drawback mentioned above.

### SUMMARY

According to an aspect of this disclosure, an opening and closing apparatus for an opening and closing member includes a support member, a plurality of pulleys supported at the support member, a transmission belt wound at the plurality of pulleys and connected to the opening and closing member, the transmission belt being configured to be driven by an electric drive source to move for opening and closing the opening and closing member, the plurality of pulleys including a pair of driven pulleys which are arranged at opposed end portions of the support member in an opening and closing direction of the opening and closing member, a first support wall portion provided at least at one of the opposed end portions of the support member and including a first support recess portion, a second support wall portion including a second support recess portion which is coaxial with the first support recess portion, the second support wall portion being disposed to face the first support wall portion, and a support pin including a first end portion which is fitted in the first support recess portion and which is formed at a first end in an axial direction of the support pin, a second end portion fitted in the second support recess portion and formed at a second end opposite from the first end in the axial direction, and a shaft portion formed at an intermediate portion in the axial direction to be sandwiched between the first support wall portion and the second support wall portion and rotatably supporting each of the driven pulleys, the shaft portion being eccentric relative to the first end portion and the second end portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a step panel of an opening and closing apparatus for an opening and closing member according to an embodiment disclosed here;

FIGS. 2A and 2B are longitudinal cross-section views illustrating a driven pulley according to the embodiment;

FIG. 3 is a perspective view of a vehicle at which the opening and closing apparatus according to the embodiment is employed;

FIGS. 4A and 4B are a plan view and a side view respectively illustrating a modified example of a support pin; and

FIGS. 4C and 4D are a plan view and a side view respectively illustrating a further modified example of the support pin.

### DETAILED DESCRIPTION

An embodiment will be explained with reference to the attached drawings. In the following, a front-rear direction corresponds to a vehicle front-rear direction, and an upper side (i.e., a top) and a lower side (i.e., a bottom) correspond to an upper side and a lower side in a vehicle height direction respectively. Further, a vehicle inner side and a vehicle outer side correspond to an inner side in a vehicle width direction towards a vehicle cabin and an outer side in the vehicle width direction away from the vehicle cabin respectively.

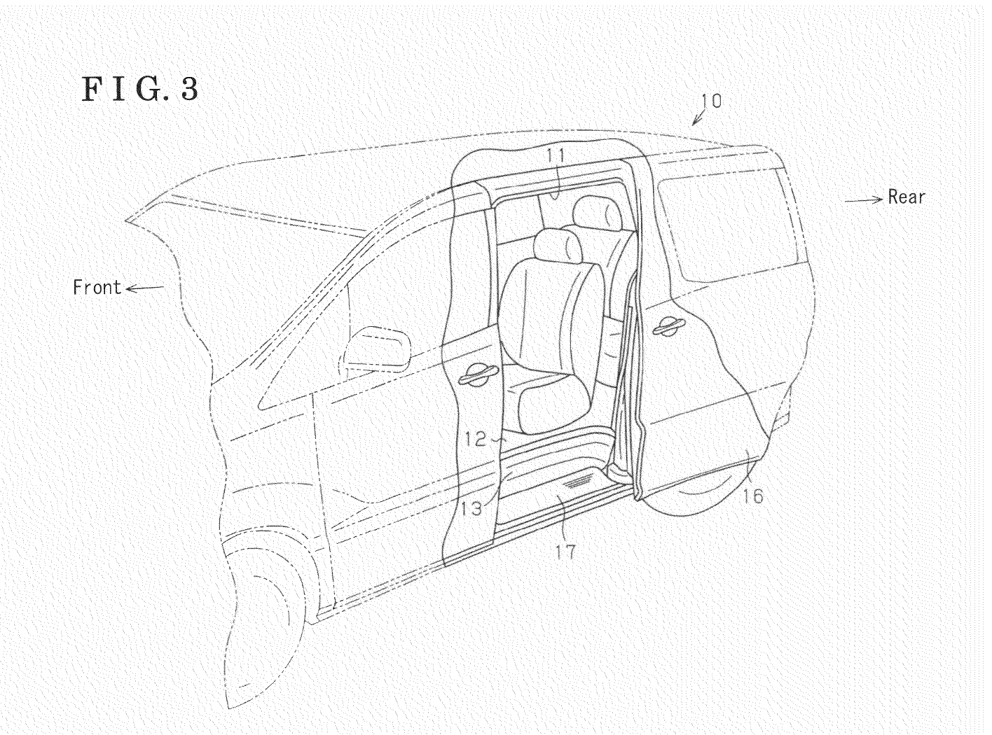

As illustrated in FIG. 3, an opening 11 through which a passenger gets in and out of a vehicle is formed at a body 10 for the vehicle. A slide door 16 serving as an opening and closing member for opening and closing the opening 11 is supported at the body 10 to be movable in the front-rear direction. In addition, a recess portion 13 is formed at a floor 12 for the vehicle so as to face the opening 11. A step panel 17 serving as a support member and functioning as a step when a passenger gets in and out of the vehicle is mounted to the recess portion 13.

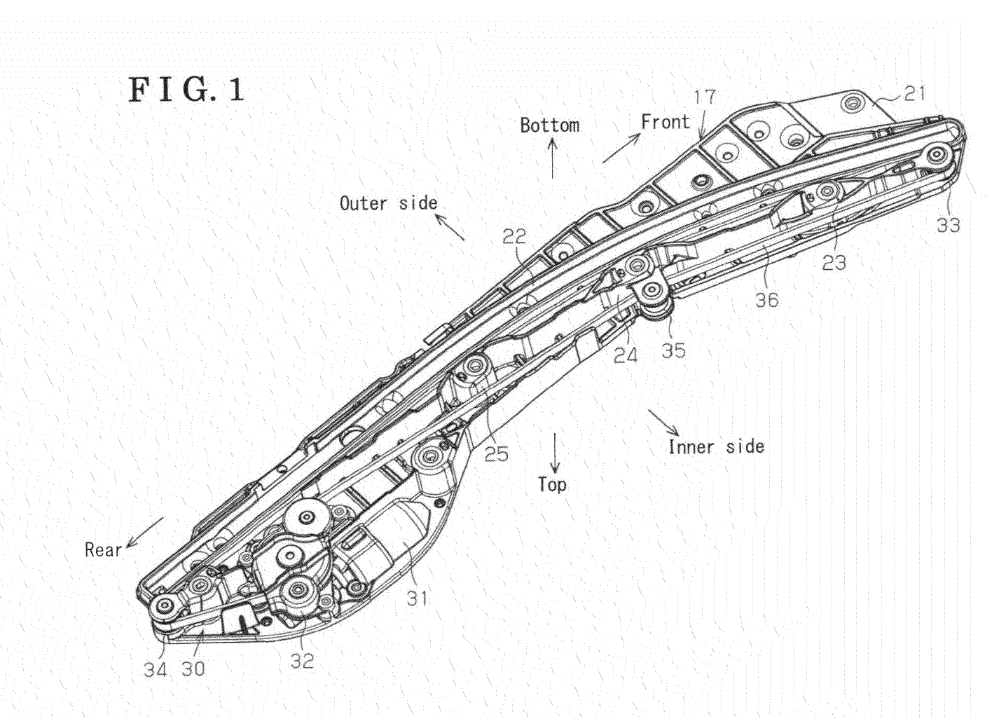

As illustrated in FIG. 1, the step panel 17 made of resin material, for example, includes a body portion 21 formed substantially in a plate form extending in the front-rear direction, and a lower rail 22 protruding downward from a portion of the body portion 21 at the vehicle outer side. The lower rail 22 extends in the front-rear direction substantially along the body portion 21. The step panel 17 also includes plural guide walls 23, 24 and 25 which are disposed adjacent to the lower rail 22 at the vehicle inner side and which protrude downward from the body portion 21. The guide walls 23, 24 and 25 are arranged substantially along the lower rail 22 in a state to be spaced away from one another in the front-rear direction.

A drive unit 30 is mounted at the body portion 21 to be adjacent thereto at the vehicle inner side. The drive unit 30 includes a motor equipped with reduction gears (which will be hereinafter simply referred to as a motor 31) which serves as an electric drive source and which is fixed to the body portion 21 at a rear side of the guide wall 25, and a driving pulley unit 32 which serves as a pulley and which is driven to rotate by the motor 31. The drive unit 30 also includes toothed driven pulleys 33 and 34 serving as a pair of pulleys supported at a front end and a rear end of the body portion 21. That is, the driven pulleys 33 and 34 are arranged at opposed end portions of the step panel 17 in an opening and closing direction of the slide door 16. Each of the driven pulleys 33 and 34 is supported to be rotatable about an axis line that extends in the vehicle height direction. The drive unit 30 further includes an idler pulley 35 serving as the pulley which is disposed at a portion of the body portion 21 to be adjacent to the guide wall 24 at the vehicle inner side thereof. The idler pulley 35 is supported to be rotatable about an axis line that extends in the vehicle height direction.

The drive unit 30 further includes an endless toothed belt 36 which serves as a transmission belt wound at the driven pulleys 33, 34 and the like, and which is formed in a ring form. A side portion (a first-side portion) of the endless toothed belt 36 at a side closer to (i.e., facing) the lower rail 22 in a case where the endless toothed belt 36 rolls rearward in a state to be meshed or engaged with the driven pulley 33 extends towards the driven pulley 34 while being in contact with respective portions of the guide walls 23, 24 and 25 which face the lower rail 22. Then, a side portion (a second-side portion) of the endless toothed belt 36 at a side away from the lower rail 22 in a case where the endless toothed belt 36 rolls forward in a state to be meshed or engaged with the driven pulley 34 is meshed or engaged with the driving pulley unit 32. The side portion of the endless toothed belt 36 also engages with the idler pulley 35 at a portion between the idler pulley 35 and the guide wall 24 and extends towards the driven pulley 33 while being contact with a portion of the guide wall 23 which is away from the lower rail 22. Thus, in a case where the motor 31 drives the driving pulley unit 32 to rotate, the endless toothed belt 36 moves in either the front direction or the rear direction corresponding to a rotation direction of the driving pulley unit 32 substantially along the lower rail 22 while the driven pulleys 33, 34 and the like are driven to rotate.

The slide door 16 is connected and fixed via a guide roller unit to a predetermined position at the first-side portion of the endless toothed belt 36 disposed closer to the lower rail 22 and is slidably connected to the lower rail 22. Thus, in a case where the endless toothed belt 36 moves in the front-rear direction, the slide door 16 is guided by the lower rail 22 to move in the front-rear direction in association with the movement of the endless toothed belt 36.

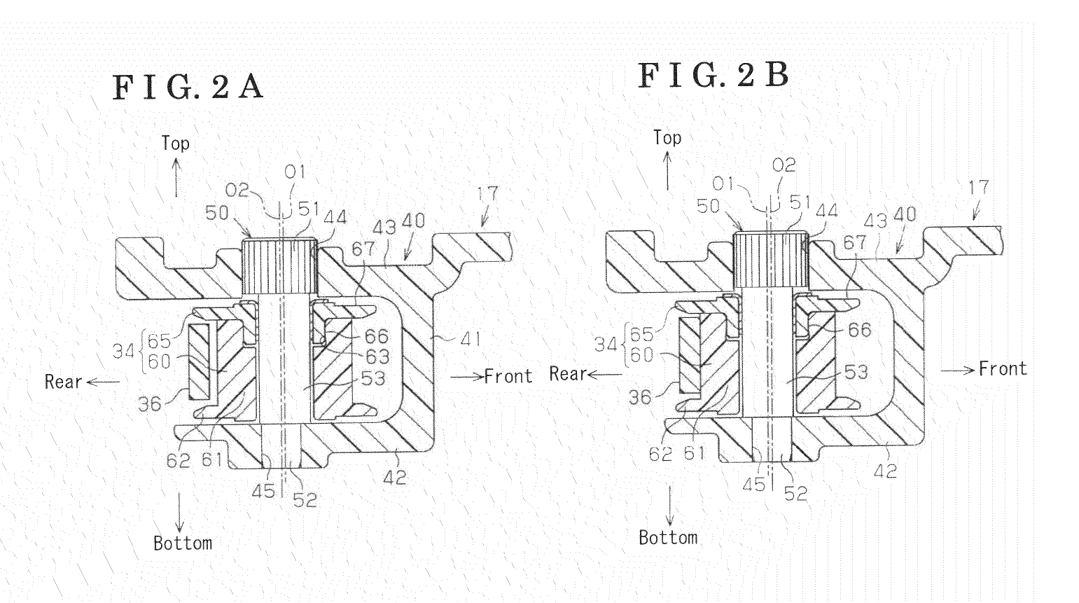

Next, a support structure of the driven pulley 34 provided at a rear side (i.e., at the rear end of the step panel 17) will be explained. A pulley support portion 40 as illustrated in FIGS. 2A and 2B is formed at the rear end of the step panel 17. The pulley support portion 40 includes a longitudinal wall 41 extending in the vehicle height direction, and a pair of support wall portions, i.e., a first support wall portion 43 and a second support wall portion 42, each of which is formed in a plate form. The first support wall portion 43 and the second support wall portions 42 extend rearward from a lower end portion and an upper end portion of the longitudinal wall 41 respectively. The pulley support portion 40 includes a substantially U-shaped cross section opening rearward. The first and second support wall portions 43 and 42 are disposed to face in the vehicle height direction so as to be substantially parallel to each other.

A first insertion bore 44 in a circular form serving as a first support recess portion is formed at the first support wall portion 43 by penetrating the first support wall portion 43 (i.e., a substantially center portion thereof) in the vehicle height direction. In addition, a second insertion bore 45 in a circular form serving as a second support recess portion is formed at the second support wall portion 42 by penetrating the second support wall portion 42 (i.e., a substantially center portion thereof) in the vehicle height direction so as to be coaxial with the first insertion bore 44.

An inner diameter of the second insertion bore 45 is specified to be smaller than an inner diameter of the first insertion bore 44.

A support pin 50 of which an axis line extends in the vehicle height direction is supported at the pulley support portion 40. The support pin 50 includes a first end portion 51 and a second end portion 52 formed at respective end portions (i.e., a first end and a second end) in a direction of the axis line (i.e., an axial direction) of the support pin 50. Each of the first end portion 51 and the second end portion 52 is formed in a substantially column form. The support pin 50 also includes a shaft portion 53 formed substantially in a column form at a center portion in the axial direction and sandwiched between the first end portion 51 and the second end portion 52.

The first end portion 51 includes an outer diameter substantially the same as the inner diameter of the first insertion bore 44 while the second end portion 52 includes an outer diameter substantially the same as the inner diameter of the second insertion bore 45. The first end portion 51 and the second end portion 52 are fitted in the first and second insertion bores 44 and 45, respectively, in a press-fitted manner. Plural fine tooth are marked and formed at an outer peripheral portion of the first end portion 51 to face in a circumferential direction thereof for reinforcing a holding force obtained by the press-fitting.

The shaft portion 53 is sandwiched between the first and second support wall portions 43 and 42 while including an axial dimension or length substantially the same as a distance between the first and second support wall portions 43 and 42. In addition, the shaft portion 53 includes an outer diameter of an intermediate value between the outer diameters of the first end portion 51 and the second end portion 52. The shaft portion 53 is eccentric relative to the first end portion 51 and the second end portion 52. That is, a center line 01 of the shaft portion 53 is in parallel offset relation to a center line 02 of the first end portion 51 and the second end portion 52.

The support pin 50 is assembled on the pulley support portion 40 from an upper side to a lower side. That is, the support pin 50 is configured to be assembled in a direction from the first insertion bore 44. Thus, the second end portion 52 and the shaft portion 53 are sequentially loosely inserted into the first insertion bore 44 of the first support wall portion 43 so that the first end portion 51 is press-fitted in the first insertion bore 44. Then, a lower end of the shaft portion 53 engages with a peripheral edge portion at an upper end of the second insertion bore 45 so that the support pin 50 is restricted from moving downward. At this time, the second end portion 52 is inserted to be positioned within (fitted in) the second insertion bore 45 of the second support wall portion 42. Accordingly, the support pin 50 is supported at the pulley support portion 40 while being inhibited from disengaging therefrom.

The driven pulley 34 is disposed between the first and second support wall portions 43 and 42. The driven pulley 34 is rotatably supported at the support pin 50 in a state where the shaft portion 53 is inserted to be positioned within the driven pulley 34. The driven pulley 34 includes a body portion 60 and a plate portion 65 made of resin material, for example. The body portion 60 includes a belt pulley portion 61 substantially in a cylindrical form including an inner diameter substantially the same as the outer diameter of the shaft portion 53, and a stopper portion 62 formed in a substantially annular form extending outwardly from a lower end of the belt pulley portion 61. An attachment groove 63 recessed downward from an upper end of the belt pulley portion 61 is formed in a substantially annular form at an inner peripheral portion of the belt pulley portion 61. Plural teeth are formed at an outer peripheral portion of the belt pulley portion 61 to extend parallel to the axial direction at even intervals over entire circumference. The plural teeth are formed to be meshed or engaged with the endless toothed belt 36.

The plate portion 65 includes an insertion portion 66 substantially in a cylindrical form and a stopper portion 67 substantially in an annular form. The insertion portion 66 includes an inner diameter substantially the same as the outer diameter of the shaft portion 53 and an outer diameter substantially the same as an inner diameter of the attachment groove 63. The stopper portion 67 extends outwardly from an upper end of the insertion portion 66. The insertion portion 66 is press-fitted in the attachment groove 63 in a state where a lower end of the stopper portion 67 is in contact with an upper end of the belt pulley portion 61 so that the plate portion 65 is secured to the body portion 60. The driven pulley 34 within which the shaft portion 53 is positioned by insertion is restricted from moving in the vehicle height direction by the first and second support wall portions 43 and 42. The stopper portion 67 includes an outer diameter substantially the same as an outer diameter of the stopper portion 62 of the body portion 60 so as to inhibit, along with the stopper portion 62, the endless toothed belt 36 meshed or engaged with the belt pulley portion 61 from disengaging in the vehicle height direction.

Next, a function of the embodiment will be explained. The shaft portion 53 of the support pin 50 is eccentric relative to the first end portion 51 and the second end portion 52. Accordingly, a distance between the driven pulleys 33 and 34 is adjustable by changes of rotation positions of the first end portion 51 and the second end portion 52 relative to the first and second insertion bores 44 and 45 to thereby change the position of the shaft portion 53.

For example, as illustrated in FIG. 2A, in a state where the center line 01 of the shaft portion 53 is positioned forward relative to the center line 02 of the first end portion 51 and the like, the shaft portion 53 is positioned closer, together with the driven pulley 34, to the driven pulley 33 so that the distance between the driven pulleys 33 and 34 decreases. On the other hand, in a case where the center line 01 of the shaft portion 53 is positioned rearward relative to the center line 02 of the first end portion 51 and the like as illustrated in FIG. 2B, the shaft portion 53 is away, together with the driven pulley 34, from the driven pulley 33 so that the distance between the driven pulleys 33 and 34 increases.

In consequence, the tension of the endless toothed belt 36 is adjusted in association with the adjustment of the distance between the driven pulleys 33 and 34.

According to the aforementioned embodiment, the distance between the driven pulleys 33 and 34 is easily adjustable by the adjustment of the rotation positions of the first end portion 51 and the second end portion 52 relative to the first and second insertion bores 44 and 45 so as to change the position of the shaft portion 53 that is eccentric relative to the first end portion 51 and the second end portion 52. The adjustment of the distance between the driven pulleys 33 and 34 may lead to an effective adjustment of the tension of the endless toothed belt 36. In order to adjust the tension of the endless toothed belt 36, the rotation positions of the first end portion 51 and the second end portion 52 relative to the first and second insertion bores 44 and 45 are simply adjusted. Thus, an increase of manufacturing hours may be restrained and a cost reduction may be achieved.

In the embodiment, the pulley support portion 40 is integrally formed at the step panel 17. Thus, an attachment bracket for fixing the driven pulley 34 to the step panel 17 is not necessary, for example, so that the number of components may be reduced.

In addition, in the embodiment, because the adjustment of the distance between the driven pulleys 33 and 34 may lead to the effective adjustment of the tension of the endless toothed belt 36, a tension pulley for adjusting the tension of the endless toothed belt 36 may be omitted.

Further, in the embodiment, even after the step panel 17 is mounted to the vehicle, the rotation positions of the first end portion 51 and the second end portion 52 are readjusted to thereby easily readjust the tension of the endless toothed belt 36.

Furthermore, in the embodiment, even in a case where a dimensional error occurs upon resin-molding of the step panel 17 by a die, the adjustment of the rotation positions of the first end portion 51 and the second end portion 52 relative to the first and second insertion bores 44 and 45 may lead to the effective adjustment of the tension of the endless toothed belt 36.

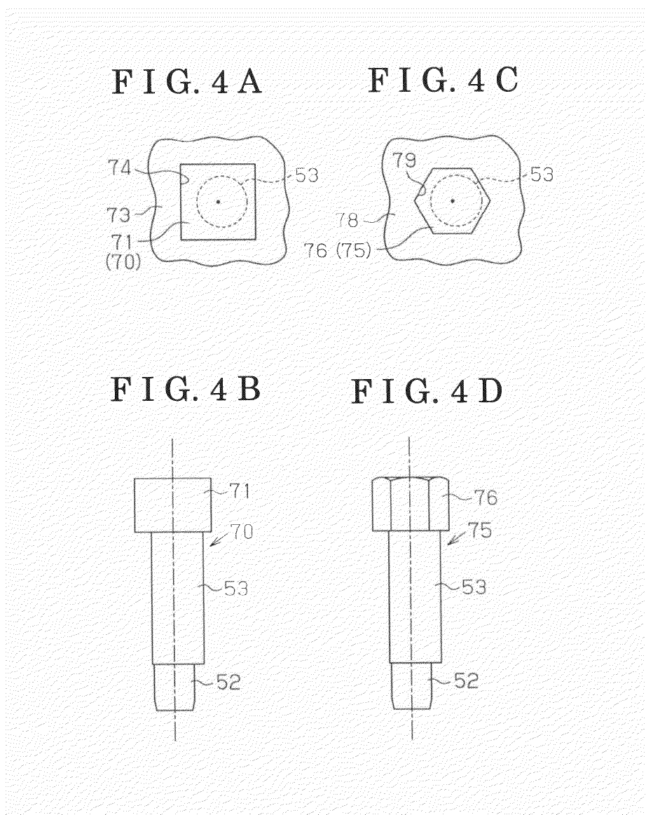

The aforementioned embodiment may be changed or modified as follows. As illustrated in FIGS. 4A and 4B, a support pin 70 including a first end portion 71 that includes a square shape when viewed in the axial direction may be employed. Specifically, the first end portion 71 includes rotational symmetry through 90° (an angle of 360°/4), i.e., four-rotational symmetry so that the first end portion 71 returns to its original position after four times rotations. In this case, an insertion bore 74 in a square form serving as the support recess portion in which the first end portion 71 is fitted by insertion may be formed at a support wall portion 73 corresponding to the first support wall portion 43.

Alternatively, as illustrated in FIGS. 4C and 4D, a support pin 75 includes a first end portion 76 that includes an equilateral hexagonal shape when viewed in the axial direction may be employed. Specifically, the first end portion 76 includes rotational symmetry through 60° (an angle of 360°/6), i.e., six-rotational symmetry so that the first end portion 76 returns to its original position after six times rotations. In this case, an insertion bore 79 in an equilateral hexagon form serving as the support recess portion in which the first end portion 76 is fitted by insertion may be formed at a support wall portion 78 corresponding to the first support wall portion 43.

Further alternatively, the support pin including the first end portion that includes any polygonal shape having rotational symmetry when viewed in the axial direction may be employed. For example, a regular polygonal shape other than a square shape and an equilateral hexagonal shape, a parallelogram shape, a cross shape, a star shape, a snow crystal shape, and the like may be employed.

Instead of the first end portion, the second end portion may include any polygonal shape having rotational symmetry when viewed in the axial direction. In addition to the first end portion, the second end portion may include any polygonal shape. In this case, the number of rotations of rotational symmetries of the first end portion and the second end portion may have an equal-multiple or integer-multiple relationship each other.

According to the aforementioned changes, in addition to the similar effect to the present embodiment, the rotation position of the first end portion (or the second end portion) relative to the corresponding insertion bore may be adjusted in a stepwise manner at an angle depending on the number of rotation symmetries of a polygonal shape. The adjusting amount of the first end portion (or the second end portion) may be therefore easily understood. In addition, the first end portion (or the second end portion) is fitted in the insertion bore in the polygonal shape that is formed to match the polygonal shape of the first end portion (or the second end portion). As a result, the support pin may be surely inhibited from disengaging from the support wall portion.

Instead of forming a polygonal shape having rotational symmetry when viewed in the axial direction, the first end portion or the second end portion may include other shapes, for example, an elongated circular shape (for example, a so-called width across flat shape obtained by cutting out an oval or a circle by a pair of straight lines opposing each other).

In the embodiment, the first end portion or the second end portion may be fitted in the support recess portion which is inhibited from penetrating through the support wall portion. In addition, the driven pulley 33 may include the same support structure as the support structure of the driven pulley 34. Accordingly, the distance between the driven pulleys 33 and 34 may be adjusted within a double range as compared to a case where the distance is adjusted by the single driven pulley 34. In this case, the support structure of the driven pulley 34 may be appropriately changed.

In the embodiment, the step panel 17 made of resin is employed. Alternatively, the step panel 17 made of other than resin, for example, made of metal, may be employed. In addition, in the embodiment, the step panel 17 is employed also as the support member. Alternatively, the support member may be separately employed from the step panel 17.

Instead of a combination of the toothed driven pulleys 33, 34 and the endless toothed belt 36, a combination of toothless pulleys and a toothless endless belt or a wire serving as the transmission belt may be employed. Further alternatively, a combination of a sprocket serving as the pulley and a chain serving as the transmission belt may be employed.

The opening and closing member may include a swing door, a tailgate, a trunk lid, a sunroof, a window glass and the like. In a case where the tension of the endless toothed belt 36 is adjusted in a state where the support pin 50, 70 or 75 is mounted to the step panel 17 at a prototype stage, i.e., the step panel 17 before a production version, a position of a portion of a die for forming the step panel 17 may be adjusted so that a center of the support recess portion (the insertion bore) matches the center line of the shaft portion 53 after the adjustment of the tension of the endless toothed belt 36. In this case, a necessary tension (tension after the adjustment) may be obtained even in a case where a general-purpose support pin which does not have eccentricity relative to the first end portion (or the second end portion) is employed at the step panel 17 at the product stage.

The drive unit 30 may be mounted to the step panel 17 at the prototype stage, i.e., the step panel 17 before the production version, to confirm the tension of the endless toothed belt 36 and to adjust a position of a portion of the die for forming the step panel 17 where the support recess portion (the insertion bore) is formed for adjusting the tension of the endless toothed belt 36 depending on a magnitude of the tension. In this case, a necessary tension (tension after the adjustment) may be obtained even in a case where a general-purpose support pin which does not have eccentricity relative to the first end portion (or the second end portion) is employed at the step panel 17 at the product stage. The position adjustment is necessary at a portion of the die related to forming the support recess portion (the insertion bore) for supporting either the driven pulley 33 or 34.

According to the aforementioned embodiment, the tension of the endless toothed belt 36 may be effectively adjusted without an increase of manufacturing hours.

In the embodiment, at least one of the first end portion 71, 76 and the second end portion 52 includes a polygonal shape including rotational symmetry.

In addition, in the embodiment, the first support recess portion and the second support recess portion are the insertion bores 44 and 45. The inner diameter of the second insertion bore 45 is specified to be smaller than the inner diameter of the first insertion bore 44. The support pin 50 is configured to be assembled in a direction from the first insertion bore 44.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An opening and closing apparatus for an opening and closing member, comprising:
a support member;
a plurality of pulleys supported at the support member;
a transmission belt wound at the plurality of pulleys and connected to the opening and closing member, the transmission belt being configured to be driven by an electric drive source to move for opening and closing the opening and closing member;
the plurality of pulleys including a pair of driven pulleys which are arranged at opposed end portions of the support member in an opening and closing direction of the opening and closing member,
a first support wall portion provided at least at one of the opposed end portions of the support member and including a first support recess portion;
a second support wall portion including a second support recess portion which is coaxial with the first support recess portion, the second support wall portion being disposed to face the first support wall portion; and
a support pin including a first end portion which is fitted in the first support recess portion and which is formed at a first end in an axial direction of the support pin, a second end portion fitted in the second support recess portion and formed at a second end opposite from the first end in the axial direction, and a shaft portion formed at an intermediate portion in the axial direction to be sandwiched between the first support wall portion and the second support wall portion and rotatably supporting each of the driven pulleys, the shaft portion being eccentric relative to the first end portion and the second end portion.

2. The opening and closing apparatus according to claim 1, wherein at least one of the first end portion and the second end portion includes a polygonal shape including a rotational symmetry.

3. The opening and closing apparatus according to claim 1, wherein
the first support recess portion and the second support recess portion are insertion bores,
an inner diameter of the second support recess portion is specified to be smaller than an
inner diameter of the first support recess portion, and the support pin is configured to be assembled in a direction from the first support recess portion.
